(19) United States
(12) Patent Application Publication
(10) Pub. No.: US 2008/0103771 A1
(43) Pub. Date: May 1, 2008

(54) Method for the Distributed Construction of a Voice Recognition Model, and Device, Server and Computer Programs Used to Implement Same

(75) Inventors: Denis Jouvet, Lannion (FR); Jean Monne, Perros Guirec (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 11/667,184

(22) PCT Filed: Oct. 27, 2005
(86) PCT No.: PCT/FR05/02695

§ 371 Date: May 4, 2007

(30) Foreign Application Priority Data
Nov. 8, 2004 (FR) 0411873

(51) Int. Cl. G10L 15/06

(52) U.S. Cl. 704/250; 704/E15.007

(57) ABSTRACT

A method for the distributed construction of a voice recognition model that is intended to be used by a device comprising a model base and a reference base in which the modeling elements are stored. The method includes the steps of obtaining the entity to be modeled, transmitting data representative of the entity over a communication link to a server, determining a set of modeling parameters indicating the modeling elements, transmitting the modeling parameters to the device, determining the voice recognition model of the entity to be modeled as a function of at least the modeling parameters received and at least one modeling element that is stored in the reference base and indicated in the transmitted parameters, and subsequently saving the voice recognition model in the model base.

The present invention relates to the field of embedded speech recognition, and more particularly the field of the production of voice recognition models used in the context of embedded recognition.

A user terminal running embedded recognition captures a voice signal to be recognized from the user. It compares it with predetermined recognition models stored in the user terminal, each corresponding to a word (or a sequence of words) to recognize, among the latter, the word (or the sequence of words) that has been spoken by the user. Then it performs an operation according to the recognized word.

Embedded recognition avoids the transfer delays that occur in the case of centralized and distributed recognition, and due to the interchanges over the network between the user terminal and a server then performing all or some of the recognition tasks. Embedded recognition proves particularly effective for speech recognition tasks such as the personalized address book.

The model of a word is a set of information representing various ways of pronouncing the word (emphasis/omission of certain phonemes and/or variety of speakers, etc.). The models can also model, instead of a word, a sequence of words. It is possible to produce the model of a word from an initial representation of the word, this initial representation possibly being textual (character string) or even voiced.

In some cases, the models corresponding to the vocabulary that can be recognized by the terminal (for example, the content of the address book) are produced directly by the terminal. No connection with a server is required to produce models, but the resources available on the terminal strongly limit the capabilities of the production tools.

For proper nouns to be processed correctly, with a good prediction of the possible pronunciation variants, it is preferable to employ large exception glossaries, and wide sets of rules. Such a knowledge base cannot therefore easily be permanently installed on a terminal. When models are built locally on the user terminal, the size of the knowledge base employed is reduced because of memory size constraints (fewer rules and fewer words in the glossary), which means that the pronunciation of certain words will be badly predicted.

Furthermore, it is virtually impossible to simultaneously install knowledge bases for several languages on the terminal.

In other cases, the models are produced on a server, then downloaded to the user terminal.

For example, document EP 1 047 046 describes an architecture comprising a user terminal, comprising an embedded recognition module, and a server linked by a communication network. According to this document, the user terminal captures an entity to be modeled, for example a contact name intended to be stored in a voice address book of the user terminal. Then it sends data representative of the contact name to the server. The server uses this data to determine a reference model representative of the contact name (for example, a Markov model) and passes it on to the user terminal, which stores it in a glossary of reference models associated with the speech recognition module.

However, this architecture involves transmitting all the parameters of the reference model for each contact name to be stored to the user terminal, which means a large quantity of data to be transmitted, and therefore high costs and communication delays.

The present invention seeks to propose a solution that does not have such drawbacks.

According to a first aspect, the invention proposes a method for the distributed construction of a voice recognition model of an entity to be modeled. The model is intended to be used by a device comprising a base of constructed models and a reference base in which modeling elements are stored. The device is able to communicate with a server via a communication link. The method comprises at least the following steps:

the device obtains the entity to be modeled;

the device transmits data representative of the entity over the communication link to the server;

the server receives the data to be modeled and performs a processing to determine a set of modeling parameters indicating modeling elements from this data;

the server transmits the modeling parameters over the communication link to the device;

the device receives the modeling parameters and determines the voice recognition model of the entity to be modeled as a function of at least the modeling parameters and at least one modeling element stored in the reference base and indicated in the transmitted modeling parameters; and

the device stores the voice recognition model of the entity to be modeled in the base of constructed models.

In one advantageous embodiment of the invention, the device is a user terminal with embedded voice recognition.

The invention thus makes it possible to benefit from the power of resources available on a server and so not to be limited in the first steps in constructing the model by memory size constraints specific to the device, for example a user terminal, while limiting the quantity of data transferred over the network. In practice, the transferred data does not correspond to the complete model corresponding to the entity to be modeled, but to information that will enable the device to construct the complete model, relying on a generic knowledge base stored in the device.

Moreover, through centralized upgrading, maintenance and/or updating operations, performed on the knowledge bases of the server, the invention makes it possible to have the devices benefit from these changes.

According to a second aspect, the invention proposes a device able to communicate with a server via a communication link. It comprises:

a base of constructed models;

a reference base in which modeling elements are stored;

means for obtaining the entity to be modeled;

means for transmitting data representative of the entity over the communication link to the server;

means for receiving modeling parameters from the server, corresponding to the entity to be modeled and indicating modeling elements;

means for determining the voice recognition model of the entity to be modeled as a function of at least the transmitted modeling parameters and at least one modeling element stored in the elementary modeling base and indicated in the received modeling parameters; and

means for storing the voice recognition model of the entity to be modeled in the constructed model base.

The device is suitable for implementing the steps of a method according to the first aspect of the invention which are the responsibility of the device, to construct the model of the entity to be modeled.

In one embodiment, the device is a user terminal intended to perform embedded voice recognition using embedded voice recognition means for comparing data representative of an audio signal to be recognized captured by the user terminal with voice recognition models stored in the user terminal.

According to a third aspect, the invention proposes a server for performing some of the tasks for producing voice recognition models intended to be stored and used by a device able to communicate with the server via a communication link. The server comprises:

means for receiving data to be modeled, transmitted by the device, via the communication link;

means for performing a processing to determine a set of modeling parameters indicating modeling elements from said data;

means for transmitting the modeling parameters over the communication link to the device.

The server is also suitable for implementing the steps of a method according to the first aspect of the invention which are the responsibility of the server.

According to a fourth aspect, the invention proposes a computer program for constructing voice recognition models from an entity to be modeled, that can be executed by a processing unit of a device intended to perform embedded voice recognition. This user program comprises instructions for executing the steps, which are the responsibility of the device, of a method according to the first aspect of the invention, when the program is executed by the processing unit.

According to a fifth aspect, the invention proposes a computer program for constructing voice recognition models, that can be executed by a processing unit of a server and that comprises instructions for executing the steps, which are the responsibility of the server, of a method according to the first aspect of the invention, when the program is executed by the processing unit.

Other characteristics and advantages of the invention will become more apparent on reading the description that follows. This is purely illustrative and should be read in light of the appended drawings in which:

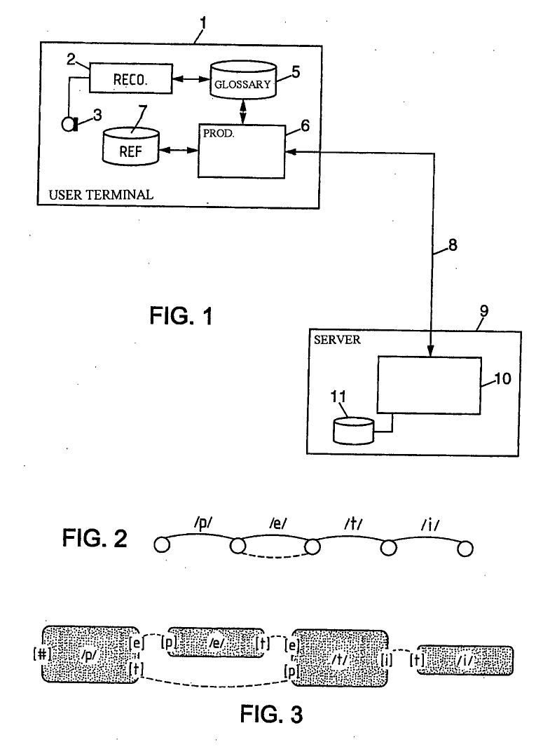

FIG. 1 represents a system comprising a user terminal and a server in an embodiment of the invention;

FIG. 2 represents a lexical graph determined from the character string “Petit” by a server in an embodiment of the invention;

FIG. 3 represents a lexical graph determined from the character string “Petit” with contexts taken into account by a server in an embodiment of the invention;

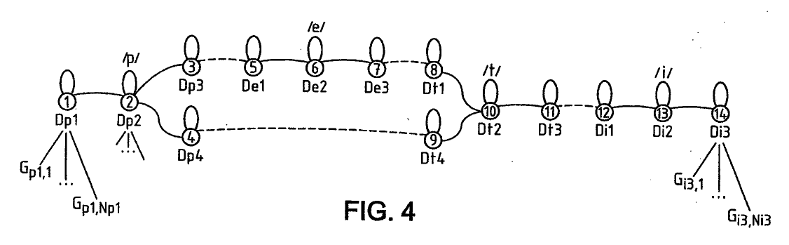

FIG. 4 represents an acoustic modeling graph determined from the character string “Petit” by a server in an embodiment of the invention.

FIG. 1 represents a user terminal 1, which comprises a voice recognition module 2, a glossary 5 storing recognition models, a model-producing module 6 and a reference base 7.

The reference base 7 stores modeling elements. These elements have been supplied to it previously in a step for configuring the base 7 of the terminal, in the factory or by downloading.

The application of the voice recognition applied by the module 2 to the voice address book is considered below.

In this case, each contact name in the address book is associated with a respective recognition model stored in the glossary 5, which thus comprises all the recognizable contact names.

When the user pronounces the name of a contact to be recognized, the corresponding signal is captured using a microphone 3 and supplied as input to the recognition module 2. This module 2 applies a recognition algorithm analyzing the signal (for example, by performing an acoustic analysis to determine a sequence of frames and associated cepstral coefficients) and determining whether it corresponds to one of the recognition models stored in the glossary 5. If it does, that is, when the voice recognition module has recognized the name of the contact, the user terminal 1 then dials the telephone number stored in the voice address book in conjunction with the recognized contact name.

The models stored in the glossary 5 are, for example, Markov models corresponding to the names of the contacts. It will be remembered that a Markov model is constructed by associating a set of probability density functions and a Markov string. It makes it possible to compute the probability of an observation X for a given message m. The document “Robustesse et flexibilitè en reconnaissance automatique de la parole” (Robustness and flexibility in automatic speech recognition) by D. Jouvet, Echo des Recherches, No. 165, 3rd quarter 1996, pp. 25-38, describes in particular speech Markov modeling.

According to the invention, the production of the recognition models stored in the glossary 5 is distributed between the user terminal 1 and a server 9. The server 9 and the user terminal 1 are linked by a bidirectional link 8.

The server 9 comprises a module 10 for determining modeling parameters and a plurality of bases 11 comprising rules of lexical and/or syntactic and/or acoustic type and/or knowledge relating in particular to the variants according to languages, accents, exceptions in the field of proper nouns, etc. The plurality of bases 11 thus makes it possible to obtain all the possible pronunciation variants of an entity to be modeled, when a modeling of this type is desired.

The user terminal 1 is suitable for obtaining an entity to be modeled (in the case considered here, the contact name “PETIT”) supplied by the user, for example in textual form, via keys on the user terminal 1.

The user terminal 1 then sets up a link in data mode via the communication link 8 and sends the character string “Petit” corresponding to the word “PETIT” to the server 9 via this link 8.

The server 9 receives the character string and performs a processing using the module 10 and the plurality of bases 11, to supply as output a set of modeling parameters indicating modeling elements.

The server 9 sends the modeling parameters to the user terminal 1.

The user terminal 1 receives these modeling parameters which indicate modeling elements, extracts the indicated elements from the reference base 7, then uses said modeling parameters and said elements to construct the model corresponding to the word “PETIT”.

In a first embodiment, the reference base 7 comprises a recognition model for each phoneme, for example a Markov model.

The modeling parameter determining module 10 of the server 9 is suitable for determining a phonetic graph corresponding to the received character string. Using the plurality of bases 11, it thus uses the received character string to determine the various possible pronunciations of the word. Then it represents each of these pronunciations in the form of a succession of phonemes.

Thus, from the received character string “Petit”, the module 10 of the server determines the following two pronunciations: p.e.t.i. or p.t.i, depending on whether the mute e is pronounced or not. These variants correspond to respective successions of phonemes, jointly represented in the form p. (e I ( ) ) .t.i or even by the phonetic graph represented in FIG. 2.

The server 9 then returns a set of modeling parameters describing these variants to the user terminal 1.

The interchange is, for example, as follows:

Terminal→Server: “Petit”

Server→Terminal: p. (e I ( )).t.i

When the user terminal receives these modeling parameters describing phoneme sequences, it constructs the model of the word “PETIT” from the phonetic graph, and from the Markov models stored in the modeling element base for each of the phonemes /p/, /e/, /t/, /i/.

Then, it stores the duly constructed Markov model for the contact name “PETIT” in the glossary 5.

Thus, the model has been constructed by using knowledge contained in the plurality of bases 11 of the server 9, but required transmission by the server, over the communication link 8, of only the parameters describing the phonetic modeling graph represented in FIG. 2, which represents a quantity of information far smaller than that corresponding to all of the model of the name “PETIT” stored in the glossary 5.

In a multilingual context, the reference base 7 of the user terminal 1 can store sets of phoneme models for multiple languages. In this case, the server 10 also transmits an indication concerning the set to be used.

In this case, the interchange will, for example, be of the type:

Terminal→Server: “Petit”

Server→Terminal: p_fr_FR.(e_FR I ( )).t_fr_FR . i_fr_FR, where the suffix _fr_FR designates phonemes from the French learned from French acoustic data (as opposed to Canadian or Belgian data, for example).

Moreover, for many proper nouns, the server 9 uses the plurality of bases 11 to detect and take into account the “assumed” source language of the name. It thus generates relevant pronunciation variants for the latter (see: “Generating proper name pronunciation variants for automatic recognition”, by K. Bartkova; Proceedings ICPhS '2003, 15th International Congress of Phonetic Sciences, Barcelona, Spain, 3-9 Aug. 2003, pp 1321-1324).

In one embodiment, to increase the subsequent recognition performance characteristics, the modeling parameter determining module 10 of the server 9 is designed also to take into account the contextual influences, that is, in this case, the phonemes that precede and that follow the current phoneme, as represented in FIG. 3.

The module 10 in one embodiment can then send modeling parameters describing the phonetic graph with contexts taken into account. In this embodiment, the reference base 7 comprises Markov models of the phonemes that take account of the contexts.

A representation of each possible pronunciation in the form of a succession of phonemes has been described above. However, other embodiments of the invention can represent pronunciations in the form of a succession of phonetic units other than the phonemes, for example polyphones (series of multiple phonemes) or sub-phonetic units which take into account, for example, the separation between the inclusion and the burst of the plosives. In this embodiment of the invention, the base 7 comprises respective models of such phonetic units.

The embodiment described above with reference to FIG. 3 relates to the case where the server takes account of the contexts. In another embodiment, it is the terminal that takes account of the contexts for the modeling, based on a lexical description (for example, a standard lexical graph simply indicating the phonemes) transmitted by the server, of the entity to be modeled.

In another embodiment of the invention, the module 10 of the server 9 is suitable for using the information sent by the terminal relating to the entity to be modeled to determine an acoustic modeling graph.

Such an acoustic modeling graph determined by the module 10 from the phonetic graph obtained from the character string “Petit” is represented in FIG. 4. This graph is the support for the Markov model, which associates a Markov string with a set of probability density functions D.

The circles, numbered 1 to 14, represent the states of the Markov string, and the arcs indicate the transitions. The labels D designate the probability density functions, which model the spectral forms that are observed on a signal and that result from an acoustic analysis. The Markov string constrains the time order in which these spectral forms should be observed. It is considered here that the probability densities are associated with the states of the Markov string (in another embodiment, the densities are associated with the transitions).

The top part of the graph corresponds to the pronunciation variant p.e.t.i, the bottom part corresponds to the variant p .t.i.

Dp1, Dp2, Dp3 designate three densities associated with the phoneme /p/. Similarly, De1, De2, De3 designate the three densities associated with the phoneme /e/; Dt1, Dt2, Dt3 designate three densities associated with the phoneme /t/ and Di1, Di2, Di3 designate the three densities associated with the phoneme /i/. The choice of three states and densities for each phoneme acoustic model (respectively corresponding to the start, the middle and the end of the phoneme) is commonplace, but not unique. In practice, it is possible to use more or fewer states and densities for each phoneme model.

Each density in fact comprises a weighted sum of several Gaussian functions defined over the space of the acoustic parameters (space corresponding to the measurements performed on the signal to be recognized). In FIG. 4, a few Gaussian functions of a few densities are diagrammatically represented.

Thus, for Dp1, the following applies for example:

$$Dp 1 ( x ) = {\sum }_{k} {α}_{p 1 , k} \times {G}_{p 1 , k} ( x )$$

where α_{p1,k} designates the weighting of the Gaussian

$${G}_{p 1 , k} ( {\sum }_{k} {α}_{p 1 , k} = 1 ) ,$$

for the density Dp1 and k varies from 1 to Np1, Np1 designating the number of Gaussians that make up the density Dp1 and that can be dependent on the density concerned.

In one embodiment of the invention, the server 9 is suitable for transmitting to the user terminal 1 information from the acoustic modeling graph determined by the module 10, which provides the list of successive transitions between states and indicates, for each state, the identifier of the associated density.

In such an embodiment, the interchange is, for example, of the type:

| Terminal -> Server: “Petit” | | |
|---|---|---|
| Server -> Terminal: <Graph-Transitions> | | |
| 1 1; | 1 2; | |
| 2 2; | 2 3; | 2 4; |
| 3 3; | 3 5; | |
| 4 4; | 4 9; | |
| 5 5; | 5 6; | |
| 6 6; | 6 7; | |
| 7 7; | 7 8; | |
| 8 8; | 8 10; | |
| 9 9; | 9 10; | |
| 10 10; | 10 11; | |
| 11 11; | 11 12; | |
| 12 12; | 12 13; | |
| 13 13; | 13 14; | |
| 14 14; | | |
| </Graph-Transitions> | | |
| <States-Densities> | | |
| 1 Dp1; | 2 Dp2; | 3 Dp3; |
| 4 Dp4; | | |
| 5 De1; | 6 De2; | 7 De3; |
| 8 Dt1; | 10 Dt2; | 11 Dt3; |
| 9 Dt4; | | |
| 12 Di1; | 13 Di2; | 14 Di3; |

<States-Densities>

The first block of information, transmitted between the markers <Graph-Transitions> and </Graph-Transitions> thus describes all the 28 transitions of the acoustic graph, with each starting state and each terminal state. The second block of information, transmitted between the markers <States-Densities> and </States-Densities>, describes the association of the densities with the states of the graph, by specifying the state/associated density identifier pairs.

In such an embodiment of the invention, the reference base 7 has probability density parameters associated with the received identifiers. These parameters are description parameters and/or density precision parameters.

For example, based on the density identifier Dp1 received, it supplies the weighted sum describing the density, and the value of the weighting coefficients and the parameters of the Gaussians involved in the summation.

When the user terminal 1 receives the modeling parameters described above, it extracts from the base 7 the parameters of the probability densities associated with the identifiers indicated in the <States-Densities> block, and constructs the model of the word “PETIT” from these density parameters and from the modeling parameters.

Then, it stores the duly constructed model for the contact name “PETIT” in the glossary 5.

In another embodiment, the server 9 is suitable for transmitting to the user terminal 1 information from the acoustic modeling graph determined by the module 10, which provides, in addition to the list of successive transitions between states and the identifier of the associated density for each state as previously, the definition of densities as a function of the Gaussian functions.

In this case, the server 9 sends the user terminal 1, in addition to the two blocks of information described previously, an additional block of information transmitted between the markers <Gaussian-Densities> and </Gaussian-Densities>, which describes, for probability densities, the Gaussians and the associated weighting coefficients, specifying the weighting coefficient/associated Gaussian identifier value pairings, of the following type when all the densities Dp1, Dp2, . . . , Di3 of the graph are to be described:

```
<Gaussian-Densities>
  Dp1 α_{p1,1} G_{p1,1} .....α_{p1,Np1} G_{p1,Np1}
  Dp2 α_{p2,1} G_{p2,1} .........α_{p2,Np2} G_{p2,Np2}
  .
  .
  .
  Di3 α_{i3,1} G_{i3,1} .........α_{i3,Ni3} G_{i3,Ni3}
</Gaussian-Densities>
```

In such an embodiment of the invention, the reference base 7 has description parameters of the Gaussians associated with the received identifiers.

When the user terminal receives the modeling parameters described above, it constructs the model of the word “PETIT” from these parameters and, for each Gaussian indicated in the <Gaussian-Densities> block, from the parameters stored in the reference base 7. Then, it stores the model duly constructed for the contact name “PETIT” in the glossary 5.

Certain embodiments of the invention can combine some of the embodiment aspects described above. For example, in one embodiment, the server knows the state of the reference base 7 of the terminal 1 and can thus determine what is stored or not stored in the base 7. It is designed to provide only the description of the phonetic graph when it determines that the models of the phonemes present in the phonetic graph are stored in the base 7. For the phonemes with models not described in the base 7, it determines the acoustic modeling graph. It supplies the user terminal 1 with the information from the <Graph-Transitions> and <States-Densities> blocks relating to the densities that it determines as known from the base 7. It also supplies the information from the <Gaussian-Densities> block relating to the densities not defined in the base 7 of the user terminal.

In another embodiment, the server 9 does not know the content of the reference base 7 of the user terminal 1, and the latter is designed, when it receives information from the server 9 comprising an identifier of a modeling element (for example, a probability density or a Gaussian) such that the reference base 7 does not include the parameters of the duly identified modeling element, to send a request to the server 9 to obtain these missing parameters in order to determine the modeling element and add to the reference base.

In the case of multilingual recognition, with the reference base 7 of the user terminal comprising modeling units for a particular language, the server 9 can search among the modeling units that it knows to be available in the reference base 7, those that most “resemble” those required by a new model to be constructed corresponding to a different language. In this case, it can adapt the modeling parameters to be transmitted to the user terminal 1 to maximize the description of the model or a modeling element absent from the base 7 and required by the user terminal, according to modeling elements stored in the base 7, thus minimizing the quantity of additional parameters to be transferred and to be stored in the terminal.

The example described above corresponds to the provision by the user terminal of the entity to be modeled in textual form, for example via the keyboard. Other ways of entering or recovering the entity to be modeled can be implemented according to the invention. For example, in another embodiment of the invention, the entity to be modeled is recovered by the user terminal 1 from a received call identifier (name/number display). In another embodiment of the invention, the entity to be modeled is captured by the user terminal 1 from one or more examples of pronunciation of the contact name by the user. The user terminal 1 then transmits these examples of the entity to be modeled to the server 9 (either directly in acoustic form, or after an analysis determining acoustic parameters, cepstral coefficients for example).

The server 9 is then designed to use the received data to determine a phonetic graph and/or an acoustic modeling graph (directly from the data, for example, in a single-speaker type approach or after determining the phonetic graph), and to send the modeling parameters to the user terminal 1. As detailed above in the case of a textual capture of the entity to be modeled, the terminal uses these modeling parameters (which mainly indicate modeling elements described in the base 7) and the modeling elements duly indicated and available in the base 7, to construct the model.

In another embodiment of the invention, the user terminal 1 is designed to optimize the glossary 5 of the constructed models, by factorizing any redundancies. This operation consists in determining the parts common to several models stored in the glossary 5 (for example, the starts or ends of identical words). It makes it possible to avoid unnecessarily duplicating computations during the decoding phase and so save on the computation resource. The factorizing of the models can concern words, complete phrases or even portions of phrases.

In another embodiment, the factorizing step is performed by the server, for example from a list of words sent by the terminal, or even from a new word to be modeled sent by the terminal and a list of words stored on the server and known by the server as listing words with models stored in the terminal.

Then, the server sends information relating to the duly determined common factors in addition to the modeling parameters indicating the modeling elements.

In another embodiment, the user terminal 1 is designed to send to the server 9, in addition to the entity to be modeled, additional information, for example the indication of the language used, in order for the server to perform a phonetic analysis accordingly, and/or the characteristics of the phonetic units to be supplied or of the acoustic models that must be used, or even the indication of the accent or of any other characterization of the speaker making it possible to generate pronunciation or modeling variants suited to this speaker (note that this information can be stored on the server, if the latter can automatically identify the calling terminal) and so on.

The inventive solution applies to all kinds of embedded recognition applications, the voice address book application indicated above being mentioned only by way of example.

Moreover, the glossary 5 described above comprises recognizable contact names; it can, however, comprise common names and/or even recognizable phrases.

Several approaches are possible for the transmission of the data between the user terminal 1 and the server 9.

This data can be compressed or not. The transmissions from the server can be done in the form of a transmittal of data blocks in response to a particular request from the terminal, or even by the transmittal of blocks with markers similar to those described above.

The examples described above correspond to the implementation of the invention in a user terminal. In another embodiment, the construction of recognition models is distributed, not between a server and a user terminal, but between a server and a gateway that can be linked to a number of user terminals, for example a residential gateway within the same home. This configuration makes it possible to share the construction of the models. According to the embodiments, once the models are constructed, voice recognition is performed exclusively by the user terminal (the constructed models are transmitted to it by the gateway), or by the gateway, or by both in the case of a distributed recognition.

The present invention therefore makes it possible to advantageously exploit multiple knowledge bases of the server (for example multilingual) to construct models, bases that cannot, for memory capacity reasons, be installed on a user terminal or residential gateway type device, while making it possible to limit the quantities of information to be transmitted over the communication link between the device and the server.

The invention also makes it much easier to implement model determination changes, since all that is required is to perform maintenance, update and upgrade operations on the bases of the server, and not on each device.

1. A method of constructing a voice recognition model of an entity to be modeled, distributed between a device comprising a base of constructed models and a reference base in which modeling elements are stored, said device being able to communicate with a server via a communication link, said method comprising at least the following steps:
obtaining by the device the entity to be modeled;
transmitting by the device data representative of said entity over the communication link to the server;
receiving by the server said data to be modeled and performing by the server a processing to determine a set of modeling parameters indicating modeling elements from said data;
transmitting by the server said modeling parameters over the communication link to the device;
receiving by the device the modeling parameters and determining by the device the voice recognition model of the entity to be modeled as a function of at least the modeling parameters and at least one modeling element stored in the reference base and indicated in the received modeling parameters; and
storing by the device the voice recognition model of the entity to be modeled in the base of constructed models.

2. The method as claimed in claim 1, wherein said device is a user terminal with embedded voice recognition, the model being intended to be used by the user terminal.

3. The method as claimed in claim 1, wherein the processing performed by the server comprises a step for determining a set of phonetic description parameters of the entity to be modeled.

4. The method as claimed in claim 1, wherein the modeling parameters transmitted to the device comprise at least one of said phonetic description parameters, an acoustic model of said phonetic description parameter being stored in the reference base of the device.

5. The method as claimed in claim 1, wherein the processing performed by the server comprises at least one acoustic modeling step, according to which the server determines a Markov model comprising a set of acoustic description parameters associated with the entity to be modeled.

6. The method as claimed in claim 5, wherein the modeling parameters transmitted to the device comprise at least one acoustic probability density identifier, the description of said identified density, comprising a weighted sum of Gaussian functions, being stored in the device reference base.

7. The method as claimed in claim 5, wherein the modeling parameters transmitted to the device comprise at least one weighting coefficient associated with a Gaussian function identifier, the duly indicated Gaussian function being defined in the reference base of the device.

8. The method as claimed in claim 1 wherein, when at least one model of an entity to be modeled has been previously stored in the base of constructed models of the device, and comprising the step of, after determining the model corresponding to a new entity to be modeled, performing by the device a model factorizing step by analyzing said previously stored model and the model corresponding to the new entity, in order to identify common characteristics.

9. The method as claimed in claim 1 comprising the step of performing by the server also a step for factorizing the models of a list of entities comprising said entity to be modeled, by analyzing said models, in order to identify common characteristics.

10. The method as claimed in claim 1 comprising the step of, when a modeling element indicated by at least one received modeling parameter is not in the reference base of the device, sending by the device sends a request to the server via the communication link, to determine the associated modeling element and recover the corresponding parameters in order to add to the reference base.

11. A device able to communicate with a server via a communication link and comprising:
a base of constructed models;
a reference base in which modeling elements are stored;
means for obtaining an the entity to be modeled;
means for transmitting data representative of said entity over the communication link to the server;
means for receiving modeling parameters from the server, corresponding to said entity to be modeled and indicating modeling elements;
means for determining the voice recognition model of the entity to be modeled as a function of at least the received modeling parameters and at least one modeling element indicated in said modeling parameters and stored in the reference base; and
means for storing the voice recognition model of the entity to be modeled in the base of constructed models.

12. A server for performing some of the tasks for building voice recognition models intended to be stored and used by a device with embedded voice recognition, the server being able to communicate with the device via a communication link and comprising:
means for receiving data to be modeled, transmitted by the device, via the communication link;
means for performing a processing to determine a set of modeling parameters indicating modeling elements from said data;
means for transmitting said modeling parameters over the communication link to the device.

13. A computer program for constructing voice recognition models from an entity to be modeled, executable by a processing unit of a device intended to perform the embedded voice recognition, said device being able to communicate with a server via a communication link and comprising a base of constructed models and a reference base in which modeling elements are stored and, said computer program comprising instructions for executing the following steps, when the program is executed by said processing unit;
obtaining an entity to be modeled;
transmitting data representative of said entity over the communication link to the server:
receiving modeling parameters from the server corresponding to said entity to be modeled and indicating modeling elements;
determining the voice recognition model of the entity to be modeled as a function of at least the received modeling parameters and at least one modeling element indicated in said modeling parameters and stored in the reference base; and
storing the voice recognition model of the entity to be modeled in the base of constructed models.

14. A computer program for constructing voice recognition models, executable by a processing unit of a server for performing some of the tasks for building voice recognition models intended to be stored and used by a device with embedded voice recognition, the server being able to communicate with the device via a communication link, comprising instructions for executing the following steps, when the program is executed by said processing unit:
receiving data to be modeled, transmitted by the device, via the communication link;
performing a processing to determine a set of modeling parameters indicating modeling elements from said data;
transmitting said modeling parameters over the communication link to the device.
